(19) United States
(12) Patent Application Publication
(10) Pub. No.: US 2025/0389692 A1
(43) Pub. Date: Dec. 25, 2025

(54) Sensor device for detecting foreign objects in a container filled with a filling material

(71) Applicant: Balluff GmbH, Neuhausen auf den Fildern (DE)

(72) Inventors: Albert Dorneich, Ostfildern (DE); Mark Eberspächer, Frickenhausen (DE)

(73) Assignee: Balluff GmbH, Neuhausen auf den Fildern (DE)

(21) Appl. No.: 19/234,799

(22) Filed: Jun. 11, 2025

(30) Foreign Application Priority Data
Jun. 24, 2024 (DE) 102024117731.4

(51) Int. Cl. G01N 27/82; B65G 15/00

(52) U.S. Cl. CPC G01N 27/82; B65G 15/00; B65G 2201/0235; B65G 2203/0208; B65G 2203/043

(57) ABSTRACT

A sensor device (10) for detecting foreign objects (8) in a container (2) filled with a filling material (1), comprises: a magnetic field source (3), at least one magnetic flux conductor (5), a magnetic quantum sensor (4) that is arranged in a first position in the magnetic flux generated by the magnetic flux conductor (5), an opening (11), which is arranged in a second position in the magnetic flux conducted by the at least one magnetic flux conductor (5) and through which the container (2) can be moved, and a control and evaluation unit (6) for controlling the magnetic field source and for evaluating the signals emitted by the magnetic quantum sensor (4).

The present invention relates to a sensor device for detecting foreign objects in a container filled with a filling material.

In the food or pharmaceutical industry, filling materials such as food or medicines are very often filled into containers, and these containers are then sold in shops. Here, it must be ensured that there are no foreign objects in the filling materials that could cause harm to people, for example in the case of foodstuffs such as baby food and the like, or medicines. It must therefore be ruled out that containers filled with a filling material and sold on the market contain harmful components.

Here, in particular, very small foreign objects should also be detected. Various physical methods can be used to detect such foreign objects. Such a method is, for example, the magnetic detection of foreign objects.

Sensor devices for determining and/or monitoring process variables of a medium in a container are known from the prior art. From DE 10 2020 123 993 A1, for example, a sensor device for determining and/or monitoring a process variable of a medium in a container emerges, which has a crystal body with at least one defect, a magnetic field device for generating a magnetic field, a detection unit for detecting a magnetic field-dependent fluorescence signal of the crystal body and an evaluation unit for ascertaining at least one statement about the process variable by means of this fluorescence signal. The magnetic field device is arranged in such a way that a magnetic field can be generated in the region of the crystal body and in the region of the medium inside the container by means of the magnetic field device. The crystal body and the magnetic field device can be arranged on the outside of a wall of the container. The detection unit has an excitation unit for optical excitation of the defect and a detector for detecting the fluorescence signal.

DE 10 2021 113 201 A1 describes a sensor arrangement for determining and/or monitoring at least one process variable of a medium in a container, which is arranged at least partially inside the container. Here too, a quantum sensor is used as the magnetic field sensor, which comprises a crystal body with at least one defect.

From DE 10 2021 134 229 A1, a device for detecting foreign objects in a flowable medium in a container emerges. This device comprises a magnetic field-sensitive device that provides a microwave-free fluorescence signal and comprises a crystal body with at least one defect centre.

DE 10 2021 113 200 A1 discloses a measuring device for detecting a paramagnetic substance in a fluid, which comprises a magnetic field-sensitive element that is brought into contact with the fluid. The magnetic field-sensitive element is a crystal body with a defect or a gas cell.

Crystal bodies with defects of the type described above are particularly suitable for allowing very precise measurements, even of small measured variables. The object of the present invention is to develop a sensor device in such a way that it enables the detection of foreign objects in a container filled with a filling material, wherein preferably a crystal body with at least one defect should be used in order to also recognise foreign objects that can otherwise only be detected with great difficulty.

### DISCLOSURE OF THE INVENTION

The sensor device for detecting foreign objects in a container filled with a filling material, comprising
a magnetic field source,
a magnetic flux conductor,
a magnetic quantum sensor that is arranged in a first position in the magnetic flux generated by the magnetic flux conductor,
an opening through which the container can be moved freely. The opening is arranged in a second position in the magnetic flux guided by the magnetic flux conductor,
a control and evaluation unit for controlling the magnetic field source and for evaluating the signals emitted by the magnetic quantum sensor,
   makes it possible to detect magnetic foreign objects, which cannot be detected with conventional methods, since, for example, they cause only very slight changes to the magnetic field, which in many cases are lost in the signal noise with conventional methods. The term “magnetic foreign objects” here refers not only to ferromagnetic materials such as steel, which can be magnetised. A permeability value other than 1 is relevant.

In doing so, the sensor device uses a magnetic quantum sensor. The basic idea of the invention is to use such a magnetic quantum sensor for the contactless detection of foreign objects in a container filled with a filling material, that is not to arrange the quantum sensor on a container wall or even in the product itself, as is the case in the prior art, for example. A magnetic circuit is created by the magnetic field source, the magnetic flux conductor, the magnetic quantum sensor and the opening in which the container is placed. A change in the properties of an object causes a change in the magnetic flux in the magnetic quantum sensor, which can be detected.

The magnetic field source itself can be implemented by a permanent magnet and/or a coil and/or an electromagnetic source. The electromagnetic source generates an electromagnetic wave, the magnetic field of which is used in the case of detecting foreign objects. The electromagnetic source can be a wave type transducer, such as an antenna, or a waveguide coupling which is fed by an electronic wave generator. In this case, a purely magnetic flux conductor is not used, but instead an electromagnetic waveguide that conducts both the electric and the magnetic field.

A particularly advantageous aspect of the invention provides that a plurality of containers are moved continuously through the opening by means of a conveyor belt. In this way, a larger number of containers can be analysed in a very short amount of time. In particular, the sensor device can be arranged in a filling or packaging process in such a way that a final inspection by means of the sensor device is possible in this way.

Here, according to an aspect of the invention, it can be provided that, while each of the containers is moved through the opening, the control and evaluation unit receives the signal emitted by the magnetic quantum sensor continuously or scanned over time, and the presence of foreign objects in the container filled with the filling material is inferred in the control and evaluation unit by means of the time course of the signal. In doing so, real-time monitoring of the filled containers is possible to some extent.

Here, one or more of the following signal processing methods are preferably used in the control and evaluation unit: forming the time derivative of the signal, offset subtraction, use of threshold values.

A particularly advantageous design of the sensor device according to the invention provides that, in the control and evaluation unit, the temporal course of signals of the magnetic quantum sensor of containers filled with a filling material without foreign objects is determined and stored by a learning process and/or during ongoing operation, and in the control and evaluation unit, the presence of foreign objects is inferred by comparing the current signals during operation and the stored signals. This aspect of the invention makes it possible to implement a learning process for detecting foreign objects, whereby it is significantly improved.

Here, according to an aspect of the invention, it is advantageously provided that one or more of the following signal processing methods are implemented in the control and evaluation unit for realising the comparison of the current signals during operation and the stored signals: machine learning, correlation method, anomaly detection based on taught-in measured values.

A very advantageous aspect of the invention provides that the light emitted by the magnetic quantum sensor is modulated, and a lock-in amplifier is provided in the control and evaluation unit to suppress noise in the signal. In doing so, the signal detection is further improved.

According to an advantageous aspect of the invention, the magnetic quantum sensor is a crystal body with defects.

The crystal body with defects is preferably a diamond with at least one NV centre.

### BRIEF DESCRIPTION OF THE DRAWINGS

Exemplary embodiments of the invention are depicted in the drawings and explained in more detail in the description below.

FIG. 1 schematically shows a front view of a sensor device according to the invention

FIG. 2 shows a top view of the sensor device according to the invention according to the exemplary embodiment.

In FIG. 3, a table is depicted which shows the relative permeability number μᵣ of different materials.

In FIG. 4, the energy scheme of an NV centre is depicted without and with a magnetic field.

FIG. 5 shows the photoluminescence of an NV centre as a function of the frequency of the irradiated microwave energy.

FIG. 6 shows a schematic depiction of the quantum sensor used in the sensor device according to the invention and the properties thereof.

FIG. 7 schematically shows the foreign body detection by means of thresholds.

### EMBODIMENTS OF THE INVENTION

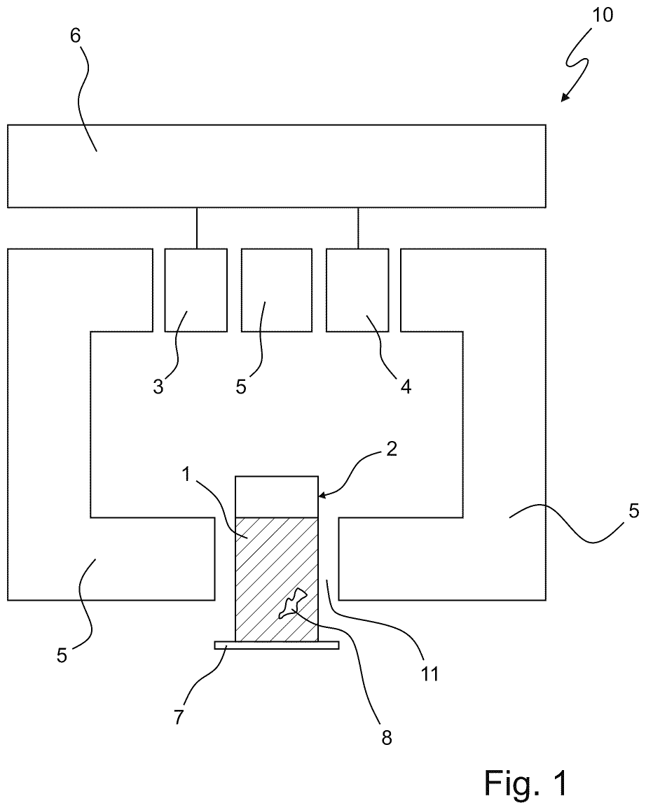

In FIG. 1, a front view of a sensor device 10 according to the invention is depicted schematically. The sensor device 10 comprises a magnetic field source, which can be realised, for example, by a permanent magnet and/or a coil and/or an electromagnetic source. The electromagnetic source generates an electromagnetic wave, the magnetic field of which is used in the case for detecting foreign objects. The magnetic field source 3 is integrated into a magnetic circuit, which is realised by one or more flux conductors 5. Furthermore, a quantum sensor 4 is also arranged in the magnetic circuit. The magnetic circuit, formed by the flux conductors 5, has an opening 11 through which the container 2, which is filled with a filling material 1, can be moved freely. The container 2 itself is transported through the opening 11 of the sensor device 10 by means of a conveyor belt 7. A foreign body 8, for example, can be present in the filling material 1, which is in the container 2. Such a foreign body 8, or more precisely a foreign body 8 that can be detected due to its magnetic properties, is to be detected by the sensor device 10 in order to prevent containers 2 with a filling material 1, which may be a foodstuff such as baby food or a medication or similar, for example, from being put on the market and causing injury to people. The magnetic field source 3 and the quantum sensor 4 are electrically connected to a control and evaluation unit 6.

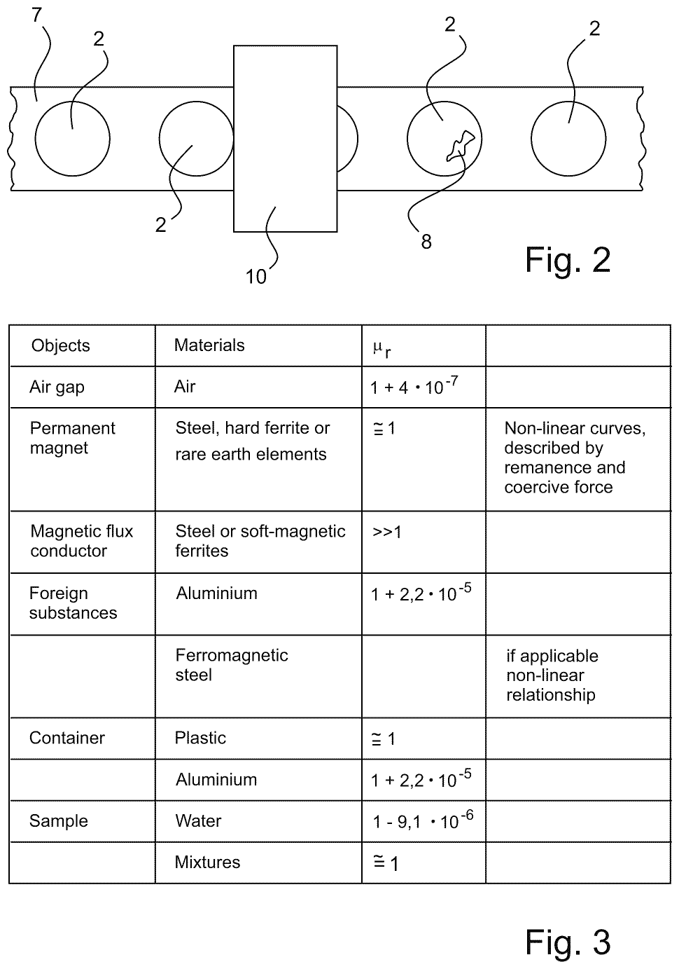

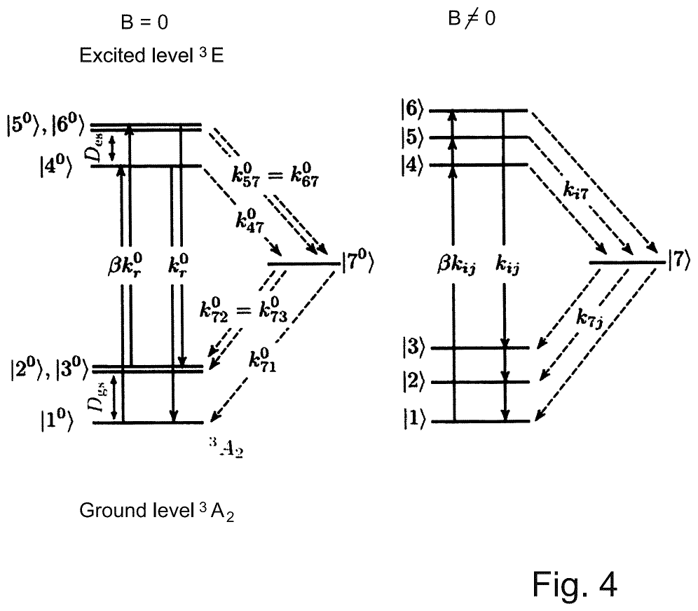

A top view of the sensor device 10 is depicted in FIG. 2. As can be seen in particular from FIG. 2, a plurality of containers 2, which are arranged on the conveyor belt 7, are continuously moved through the sensor device 10, and while the containers 2 are being moved through, it is established whether foreign objects 8 are present in the filling material 1 in the containers 2.

The magnetic field source 3 generates a magnetic flux through the magnetic flux conductor 5, through the sample, which is formed here by the container 2 filled with the filling material 1, through the magnetic quantum sensor 4 and, if necessary, through air gaps between the magnetic flux conductors 5 and the container 2. In other words, these components form a magnetic circuit.

The magnetic flux density B and the magnetic field strength H apply to all objects with the number i in the magnetic circuit:

Bᵢ=Bᵢ(Hᵢ)

In the case of a linear relationship, the following applies:

Bᵢ=μ_{r,i} μ₀ Hᵢ,
wherein the relative permeability number μᵣ is characteristic of certain materials. The table depicted in FIG. 3 shows, by way of example, some values for relevant objects and materials.

The values for Bᵢ, Hᵢ of the objects in the magnetic circuit emerge from the magnetic properties of the objects, the magnetic field source 3 and their geometric dimensions. A change in the property of an object causes a change in the magnetic flux in the magnetic quantum sensor 4. It is immediately apparent from the table depicted in FIG. 3 that, for example, a foreign body 8 made of aluminium with dimensions in the millimetre range causes a very small change in the magnetic flux density measured by the quantum sensor 4. The change in the magnetic flux density measured by the quantum sensor 4 due to magnetic foreign objects 8 is used to detect these foreign objects 8. For this purpose, it is necessary for the measurement method used to have a lower noise level than the effect to be measured by the foreign body. Quantum sensors 4 based on NV centres, which are inherently known, can achieve noise power densities of up to 0,9 pT/\sqrt{Hz}. Commercial magnetic sensors based on the AMR, GMR, TMR and Hall effect, for example, achieve values of 100 pT/\sqrt{Hz}100.

As mentioned, magnetic quantum sensors 4 are used to detect foreign objects with very small changes in the measured magnetic flux density. These magnetic quantum sensors, which have become known in recent years, differ substantially from classical sensors for magnetic field measurement. While coils, for example, can be regarded as macroscopic objects without taking atomic properties into account and Hall elements, for example, are based on the solid body effects of a large number of atoms which are arranged on sites in a crystal lattice, quantum sensors, on the other hand, use the quantum physical effects of individual or several individual objects. For technical applications, defects, also referred to as colour centres, in diamonds have proved to be favourable as such objects. The best-known system is the NV centre in diamonds, which is formed from a substitutional nitrogen atom and a neighbouring lattice gap. This defect forms a robust quantum state even at room temperature by it providing localised electronic states deep within the band gap of the diamond, as depicted schematically in FIG. 4. With a ground state (ground level) ³A₂ and an excited electronic state (exited level) ³E within the band gap, the state can be excited, which is responded to by the emission of fluorescence photons. The fluorescent light, also known as photoluminescence (PL), appears in the red to NIR spectrum, as depicted in FIG. 4 by the solid arrows. There is also a non-radiative relaxation path that uses the metastable states |7> and reduces the amount of light emitted. This is depicted in FIG. 4 by dashed arrows.

The energy states can be detected optically using the ODMR method (Optical Detected Magnetic Resonance). Optical transitions between the ground state and the excited state are spin-preserving, i.e. only transitions of from |1> to |4> are possible, but not from |1> to |5> or |6>. By coupling the spin of the NV centre with the outer magnetic field (B≠0, depicted on the right in FIG. 4), the excited states |2> and |3> or |5> and |6> are energetically split. The splitting of |1> and |2> or |3> without an outer magnetic field is referred to as zero-field splitting by the field of the diamond crystal.

The energy difference between the split energy levels |2> and |3> is

DE=g·μ_{B} B·S

μ_{B} is the Bohr magneton and g is the g-factor of the electron.

By applying a microwave field with the appropriate energy DE, the occupation of the energy levels can be influenced. The energy of a microwave photon E corresponds to the frequency f of the microwave radiation according to the following equation, where h is Planck's quantum of action:

E=h·f

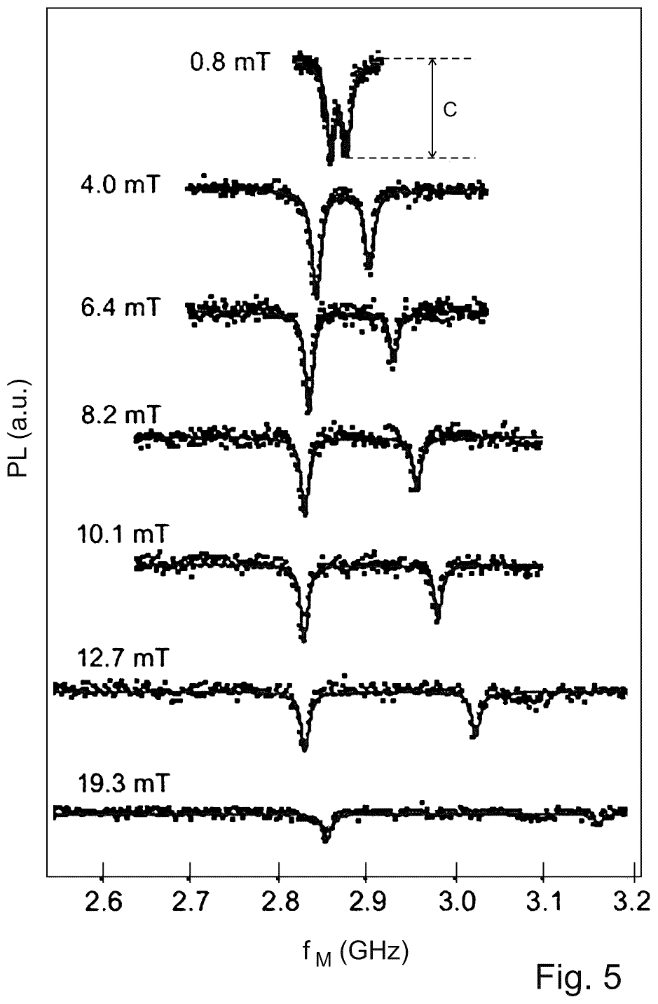

Since the transition probabilities for the radiating and non-radiating transitions depend on the occupancies of the energy levels, the photoluminescence can be significantly reduced by the irradiation of microwaves. If the microwave frequency is continuously increased between two values (frequency sweep), then sharp dips are to be observed at certain frequencies (so-called dips). The ratio of the photoluminescence at the minimum of a dip and outside the dip is referred to as contrast C. Since the frequency difference of the two dips depends only on natural constants and the external magnetic field, quantum sensors can be used to measure magnetic fields very accurately, as depicted schematically in FIG. 5. In FIG. 5, the photoluminescence is depicted in arbitrary units above the microwave frequency f_{M}.

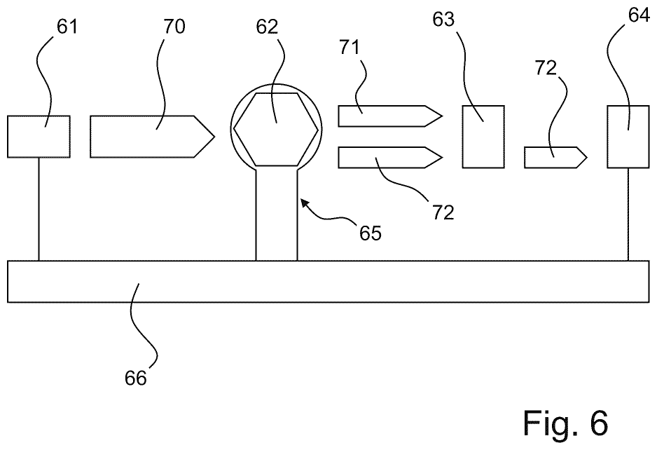

A quantum sensor 4 based on NV centres in diamond used in the present sensor device 10 is depicted schematically in FIG. 6. It consists of the following components: a light source 61, which can be a light-emitting diode or a laser diode, for example, to excite the NV centre with green light, depicted by an arrow 70. A diamond with NV centres 62, which is exposed to the green light 70. An optical filter 63 for suppressing the green excitation light, depicted by an arrow 71. A light detector 64, which can be realised for example by a photodiode, for measuring the photoluminescence in the red or near infrared range, shown by arrows 72. A microwave antenna 65 for coupling microwaves and an electronic system 66 for controlling the light source 61 and the microwave excitation and for evaluating the output signals of the light detector 64. It should be mentioned at this point that, as an alternative to using diamonds with NV centres, defects in silicon carbide or gas cells with gaseous alkali metal can also be considered as quantum sensors.

If a permanent magnet is used as the magnetic field source 3, the sample, i.e. the container 2 filled with the filling material 1, is supplied with a magnetic field that is constant over time, a so-called DC field. If a coil is used, an alternating magnetic field can be generated by alternating current excitation, a so-called AC field.

It should be emphasised at this point that the container 2 must not consist of ferromagnetic steel, since in this case the container 2 shields the sample, i.e. the filling material 1 and any foreign body 8, from the magnetic field. If the container 2 is made of conductive material, such as aluminium, a DC magnetic field must be used or the frequency must be limited in such a way that the container 2 does not shield the magnetic field due to eddy current effects. If an electromagnetic wave, for example in the range of microwaves or millimetre waves, is used, an antenna, a coupling or a wave type converter can be used, such that the electromagnetic wave enters the sample and penetrates it. Electromagnetic waves have the advantage that they do not decay quickly in space like a static magnetic field, but rather are detached from the source and can basically be transmitted without loss by means of waveguides.

The control and evaluation unit 6, which also comprises the evaluation device 66, receives continuously or time-scanned values from the quantum sensor 4, while the container 2 moves along the conveyor belt 7 in the direction of conveyance at the quantum sensor 4. The influence of a foreign body 8 here depends on the position of the container 2 relative to the quantum sensor 4. From the temporal course of the signal, influences from tolerances of the container 2, the filling material 1 and the position of the container 2 perpendicular to the direction of travel of the conveyor belt 7, fluctuations in temperature and other cross-sensitivities can be avoided and distinguished from the influence of the foreign body 8. Methods of classical signal processing such as the formation of the time derivative, an offset deduction, the use of threshold values etc. can be used for this purpose.

A further improvement is the use of measured values of the temporal course without foreign objects 8. These can be recorded either in a learning process before operation of the sensor device 10 or during ongoing operation. Here, it is assumed that foreign objects 8 are only present in rare cases during operation. The current measured values can either be analysed using classical signal processing methods, such as correlation, or using machine learning methods, such as anomaly detection based on the learned measured values. This measure also enables the separation of influences from foreign objects 8 and other undesirable influences.

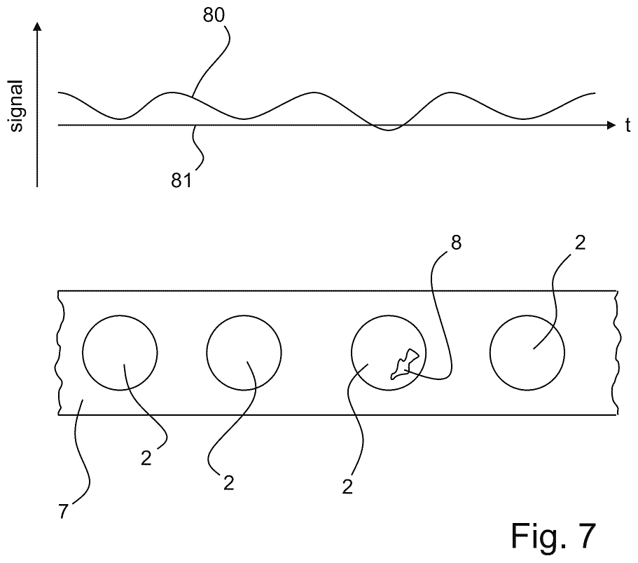

In addition, the emitted light can be modulated and a lock-in amplifier (not depicted) can be used to suppress noise in the signal from the light detector 64. In FIG. 7, foreign body detection by means of thresholds is schematically depicted. In this example, the presence of a foreign body 8 is inferred when the output signal 80 is recognised as falling below a threshold 81. The threshold 81 can be adjusted based on containers 2 without foreign objects 8. FIG. 7 depicts that, if a foreign body 8 is present, the signal 80 falls below the threshold 81, which is detected.

The advantage of the sensor device 10 described above is that it has a substantially higher degree of sensitivity than classical methods of magnetic field measurement, which are based, for example, on the Hall effect or AMR, GMR and XMR effects. Moreover, there is also no potential danger to people when using it, as could occur with X-ray detection devices, for example.

Due to the low noise of such magnetic quantum sensors 4, which can also be referred to as quantum magnetometers, very small changes in the magnetic field caused by foreign objects 8 can be detected.

1. Sensor device (10) for detecting foreign objects (8) in a container (2) filled with a filling material (1), comprising
a magnetic field source (3),
at least one magnetic flux conductor (5),
a magnetic quantum sensor (4) that is arranged in a first position in the magnetic flux generated by the magnetic flux conductor (5),
an opening (11), which is arranged in a second position in the magnetic flux conducted by the at least one magnetic flux conductor (5) and through which the container (2) can be moved, and
a control and evaluation unit (6) for controlling the magnetic field source and for evaluating the signals emitted by the magnetic quantum sensor (4).

2. Sensor device (10) according to claim 1, characterised in that the magnetic field source (3), the magnetic flux conductor (5), the magnetic quantum sensor (4) and the opening (11) for moving the container (2) through are arranged in such a way that a magnetic flux generated by the magnetic field source (3) takes place through the at least one magnetic flux conductor (5), the magnetic quantum sensor (4) and the container (2).

3. Sensor device (10) according to claim 1, characterised in that the magnetic field source (3) is realised by a permanent magnet and/or a coil and/or an electromagnetic source.

4. Sensor device (10) according to claim 1, characterised in that a plurality of containers (2) are continuously moved through the opening (11) by means of a conveyor belt.

5. Sensor device (10) according to claim 4, characterised in that, while the container (2) is moved through the opening (11), the control and evaluation unit (6) receives the signal output by the magnetic quantum sensor (4) continuously or in a time-scanned manner, and, based on the time course of the signal, the presence of foreign objects (8) in the container (2) filled with the filling material (1) is inferred by the control and evaluation unit (6).

6. Sensor device (10) according to claim 1, characterised in that one or more of the following signal processing methods are implemented in the control and evaluation unit (6): forming the time derivative of the signal, offset deduction, use of threshold values.

7. Sensor device (10) according to claim 1, characterised in that, in the control and evaluation unit (6), the temporal course of signals of the magnetic quantum sensor (4) of containers (2) filled with a filling material (1) without foreign objects (8) is determined and stored by a learning process and/or during ongoing operation, and in that in the control and evaluation unit (6) the presence of foreign objects (8) is inferred by comparing the current signals during operation and the stored signals.

8. Sensor device (10) according to claim 7, characterised in that one or more of the following signal processing methods are implemented in the control and evaluation unit (6) to realise the comparison of the current signals during operation and the stored signals: machine learning, correlation methods, detection of anomalies based on learned measured values.

9. Sensor device (10) according to claim 1, characterised in that the light emitted by the magnetic quantum sensor (4) is modulated and a lock-in amplifier is provided in the control and evaluation unit (6) for noise suppression of the signal.

10. Sensor device (10) according to claim 1, characterised in that the magnetic quantum sensor (4) is a crystal body with defects.

11. Sensor device (10) according to claim 1, characterised in that the crystal body with defects is a diamond with at least one NV centre.
